(19) United States
(12) Patent Application Publication
(10) Pub. No.: US 2007/0221634 A1
(43) Pub. Date: Sep. 27, 2007

(54) Plasma Torch Spectrometer

(75) Inventor: Geoffrey Mark Condick, Victoria (AU)

Correspondence Address: THE WEBB LAW FIRM, P.C., 700 KOPPERS BUILDING, 436 SEVENTH AVENUE, PITTSBURGH, PA, 15219, US

(73) Assignee: GBC SCIENTIFIC EQUIPMENT PTY LTD, Dandenong (AU)

(21) Appl. No.: 10/593,605

(22) PCT Filed: Mar. 17, 2005
(86) PCT No.: PCT/AU05/00388

§ 371 Date: Sep. 21, 2006

(30) Foreign Application Priority Data
Mar. 31, 2004 (AU) 2004901753

(51) Int. Cl. H05H 1/30; H01J 49/36

(52) U.S. Cl. 219/121.48; 250/288

(57) ABSTRACT

A spectrometer is disclosed which comprises a plasma torch and an induction coil for generating a normal plasma within the torch. The torch has an outer tube and an inner tube. If the plasma collapses from a normal plasma state to a toroidal or faulty plasma shape, a photodiode detects the change in shape so that the plasma torch can be shut down to prevent the plasma shape from melting the tube of the torch.

### FEILD OF THE INVENTION

This invention relates to an inductively coupled plasma torch spectrometer such as a time of flight mass spectrometer, quadrupole, UES spectrometer, or any other spectrometer which uses an inductively coupled plasma torch in order to produce sample for analysis.

### BACKGROUND ART

Sample which is required to be analysed by various types of spectrometers is often provided by an inductively coupled plasma torch. Such torches receive a coolant or plasma gas together with an auxiliary gas and a sample carrier gas. The gases are usually argon and the torch is provided with a glass quartz outer envelope or tube (hereinafter referred to as a tube) about which an RF induction coil is provided. When the gases are supplied to the torch and the coil and an ignition spark device are activated, a plasma is created and the sample material in the carrier gas is ionised for analysis in the spectrometer.

It has been found that when the plasma is created by the torch, the plasma may have two stable states. The first stable state, so-called normal plasma, produces a plasma which is constrained within the glass tube and is separated from the glass tube.

A second stable state can be produced by collapse of the plasma into a so-called toroidal or faulty plasma. Often this particular shape is referred to as a donut plasma. The donut plasma tends to spread out and make contact with the glass tube, and this in turn results in melting of the glass tube which destroys the torch.

The main cause of the shape of the plasma snapping from the normal plasma shape to the toroidal or faulty shape is insufficient coolant gas flow which may be the result of a fault. A rapid change in loading which the control system of the spectrometer cannot cope with may also cause a toroidal or faulty plasma shape.

Plasma torches are relatively expensive articles, and the need to replace plasma torches because of melting by a toroidal or faulty plasma shape is therefore a relatively expensive exercise.

### SUMMARY OF THE INVENTION

The object of the invention is to provide a spectrometer in which the torch is protected from meltdown in the event of the plasma collapsing to the toroidal or faulty plasma shape.

The present invention may therefore be said to reside in a spectrometer for analysing a sample produced by an inductively coupled plasma torch in which a normal plasma is created by application of gas to the torch and activation of an induction coil to heat the gas and therefore produce the normal plasma, and which the plasma is capable of collapsing into a toroidal or faulty plasma shape, the spectrometer comprising:
a detector for detecting a change in the plasma from a normal plasma to a toroidal or faulty plasma;
a control section for receiving a signal from the detector for determining change of plasma from the normal plasma shape to the toroidal or faulty plasma shape; and
the control section being for shutting down the torch when the control section determines that the plasma changes from the normal plasma shape to the toroidal or faulty plasma shape.

Thus, since the control section recognises when the plasma changes shape, the torch can be immediately shut off to thereby prevent the torch from melting because of contact of the toroidal plasma shape with the tube. Thus, the torch is protected and therefore replacement of the torch is not necessary. In the event of detection of the change to the faulty plasma shape, any remedial action necessary can be taken to ensure that when the spectrometer is again operated, the normal plasma shape is established.

Preferably the detector comprises an optical detector which is directed at a position at which the top region of the normal plasma will exist, so that if the normal plasma collapses into a toroidal or faulty plasma, the position of the plasma changes rapidly and the light intensity falling on the optical detector falls, thereby changing the signal produced by the optical detector so that the control section can recognise that the change in shape has occurred.

Preferably the optical detector is provided with a collimator and/or a lens for increasing the ratio of light received by the optical detector when the normal plasma is in existence, compared to the light intensity when the toroidal or faulty plasma is in existence.

In other embodiments, an optical fibre or fibres or solid waveguide may be used for conducting light to the optical detector.

In the preferred embodiment, the optical detector is a photodiode.

In a still further embodiment, the detector may be an electronic camera with suitable software to analyse the image of the plasma and determine its shape and position to thereby determine if the plasma has collapsed to the toroidal or faulty plasma shape. However, this embodiment is somewhat more complicated, requiring software to analyse the image obtained by the camera, rather than simply based on the intensity of light which the preferred embodiment of the photodiode provides.

In a still further embodiment, the detector may be a pixel array and, in particular, a linear photodiode array.

The linear photodiode array may be provided with a lens.

Preferably the induction coil includes a generator for generating power to be supplied to the coil to activate the coil, and preferably the control section switches off the generator when the control section determines the change of shape from the normal plasma to the toroidal or faulty plasma shape to shut down the torch.

In a still further embodiment, the detector may determine the impedance value of the plasma in order to determine the change from the normal plasma to the toroidal plasma.

In one embodiment, this is done by measuring the voltage and current of a high voltage DC supply which feeds the generator.

### BRIEF DESCRIPTION OF THE DRAWINGS

Preferred embodiments of the invention will be described, by way of example, with reference to the accompanying drawings in which:

FIG. 1 is a view of a spectrometer showing various embodiments of the invention;

FIG. 2 is a view showing a torch with a plasma in the toroidal or faulty plasma condition.

### DETAILED DESCRIPTION OF THE PREFERRED EMBODIMENT

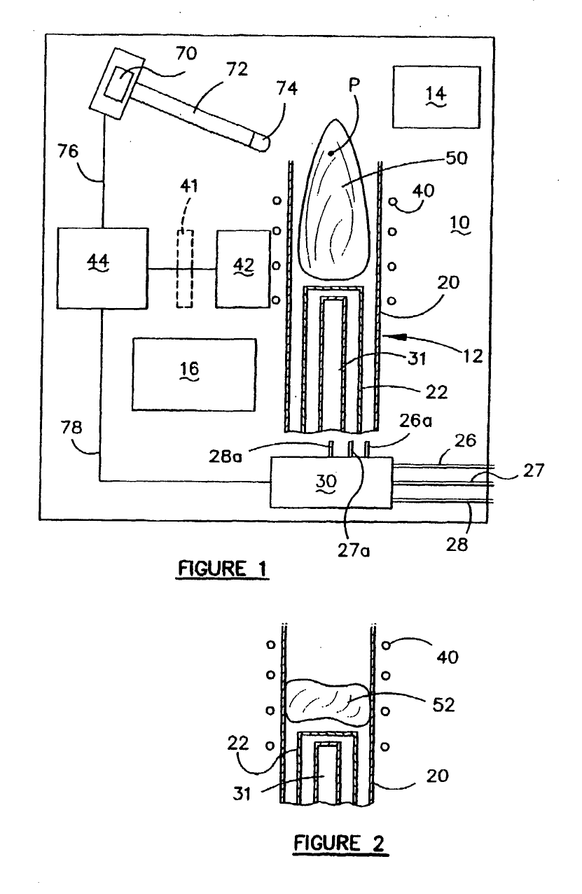

With reference to FIG. 1, a spectrometer 10 is schematically shown which uses an inductively coupled plasma torch 12 to create sample for analysis in the spectrometer 10. The spectrometer 10 is of conventional design and therefore is not described in detail, other than to say it will normally include a display 14 on which results can be displayed and a processing section 16 which controls the spectrometer and performs the analysis so that the results can be displayed on the display 14, or otherwise provided to an operator.

The plasma torch 12 has an outer tube 20 and an inner tube 22. Coolant or plasma gas is supplied from a coolant or plasma gas line 26 via one or more valves and flow control devices schematically shown at 30 to line 26a which supplies the coolant or plasma gas to the space between the outer tube 20 and inner tube 22. Auxiliary gas is supplied by line 27 through the valve and flow control section 30 to line 27a and then to the inner tube 22 and sample carrying gas is supplied by line 28 through the valve and flow control device section 30 to line 28a and then to pipe 31 which is located within the inner tube 22. An RF induction coil 40 is provided about the outer tube 20 and current is supplied to the coil 40 from an RF generator 42 which is controlled by a control section 44.

In FIG. 1 the control section 44 is shown separate from the processing section 16, but may simply form part of the processing section 16. In other words, the control section 44 may simply be regarded as part of the processing section 16 which controls the spectrometer 10 rather than a separate control section. The coolant or plasma gas and the auxiliary gas and the sample carrier gas are usually argon. When the gases are supplied to the torch 12 and the RF generator 42 activated, the coil 40 generates heat to heat the gas and therefore create the plasma in which sample material is ionised for analysis either by way of relative absorption of light, such as in an atomic absorption spectrometer or by creating ions which travel down a time of flight cavity such as in a mass spectrometer, or for any other type of appropriate analysis.

FIG. 1 shows a plasma 50 having a so-called normal stable plasma shape in which the plasma is confined within the tube 20 and spaced from the tube 20.

In some instances, it is possible for the plasma 50 to snap into a so-called toroidal or faulty plasma shape 52 (see FIG. 2) because of a number of reasons, most typically due to insufficient coolant gas flow or a rapid change in loading. The toroidal or faulty plasma shape 52 basically spreads out and makes contact with the inner surface of the outer tube 20. The inner tube 22 and outer tube 20 of the torch are typically made from quartz glass and contact of the plasma 52 with the tube 20 causes the tube 20 to melt within a few seconds if the plasma torch remains operating and the plasma 52 remains in the toroidal or faulty shape.

To prevent meltdown of the tube 20 and therefore destruction of the plasma torch, the preferred embodiments of the invention detect the change of shape of the plasma from the normal shape 50 in FIG. 1 to the toroidal or faulty shape 52 and shuts down the torch to prevent the tube 20 from melting, and therefore prevent the torch from being destroyed.

In a preferred embodiment of the invention, a photodiode 70 is provided which is focused on a region (such as point P in FIG. 1) at which the upper portion of the normal plasma shape 50 will be located when the torch 12 is operating properly. The diode 70 detects light produced by the plasma. Thus, the diode 70 is able to monitor the intensity of the light produced when the plasma has the normal plasma shape 50 as shown in FIG. 1, and a signal is provided from the diode 70 on line 76 to control section 44 indicative of the light intensity when the plasma has normal shape.

If the plasma collapses to the toroidal or faulty shape 52 shown in FIG. 2, the light intensity falling on the photodiode 70 will immediately decrease, probably by about an order of magnitude because the plasma is no longer located at the point P where the diode 70 is focused. Thus, the output from the diode 70 changes significantly, and this change can be recognised by the control section 44 as an indication that the plasma has collapsed into the toroidal or faulty shape 52. The control section 44 can then immediately shut off the RF generator 42 to shut off current through the coil 40 so the plasma is extinguished and will not melt the glass tube 20. If necessary, any remedial action can be taken to correct the spectrometer before it is again switched on to ensure that the normal plasma shape 50 is created.

Thus, the torch 20 is protected and therefore does not need to be replaced as often, as would be the case if the toroidal or faulty plasma shape 52 was maintained and caused meltdown of the glass tube 20.

In other embodiments (not shown) the diode 70 may be replaced by a linear photodiode array or an electronic camera which is programmed to analyse the image of the plasma and determine the change of shape. In a still further embodiment, the change of the plasma from the normal shape 50 to the toroidal or faulty shape 52 may be determined by detecting the impedance of the plasma.

In one embodiment, this is done by measuring the voltage and current supplied to the generator 42 from a high voltage DC supply 41. If the plasma does change to the faulty plasma shape, this will cause a change in impedance which in turn can be identified by monitoring of the voltage and current supplied to the RF generator 42 from the supply 41.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

1. A spectrometer for analysing a sample produced by an inductively coupled plasma torch in which a normal plasma is created by application of gas to the torch and activation of an induction coil to heat the gas and therefore produce the normal plasma, and which the plasma is capable of collapsing into a toroidal or faulty plasma shape, the spectrometer comprising:
a detector for detecting a change in the plasma from a normal plasma to a toroidal or faulty plasma;
a control section for receiving a signal from the detector for determining change of plasma from the normal plasma shape to the toroidal or faulty plasma shape; and
the control section being for shutting down the torch when the control section determines that the plasma changes from the normal plasma shape to the toroidal or faulty plasma shape.

2. The spectrometer of claim 1 wherein the detector comprises an optical detector which is directed at a position at which the top region of the normal plasma will exist, so that if the normal plasma collapses into a toroidal or faulty plasma, the position of the plasma changes rapidly and the light intensity falling on the optical detector falls, thereby changing the signal produced by the optical detector so that the control section can recognise that the change in shape has occurred.

3. The spectrometer of claim 1 wherein the optical detector is provided with a collimator and/or a lens for increasing the ratio of light received by the optical detector when the normal plasma is in existence, compared to the light intensity when the toroidal or faulty plasma is in existence.

4. The spectrometer of claim 1 wherein an optical fibre or fibres or solid waveguide may be used for conducting light to the optical detector.

5. The spectrometer of claim 3 wherein the optical detector is a photodiode.

6. The spectrometer of claim 1 wherein the detector is an electronic camera with suitable software to analyse the image of the plasma and determine its shape and position to thereby determine if the plasma has collapsed to the toroidal or faulty plasma shape.

7. The spectrometer of claim 1 wherein the detector is a pixel array.

8. The spectrometer of claim 7 wherein the array is a linear photodiode array and the linear photodiode array is provided with a lens.

9. The spectrometer of claim 1 wherein the induction coil includes a generator for generating power to be supplied to the coil to activate the coil, and preferably the control section switches off the generator when the control section determines the change of shape from the normal plasma to the toroidal or faulty plasma shape to shut down the torch.

10. The spectrometer of claim 1 wherein the detector is for determining the impedance value of the plasma in order to determine the change from the normal plasma to the toroidal plasma.

11. The spectrometer of claim 10 wherein the impedance value is provided by measuring the voltage and current of a high voltage DC supply which feeds the generator.
